(19) United States
(12) Patent Application Publication
(10) Pub. No.: US 2010/0242202 A1
(43) Pub. Date: Sep. 30, 2010

(54) DOUBLE LAYER ADHESIVE TROWEL

(75) Inventor: Wolfgang Stauf, Collierville, TN (US)

Correspondence Address: BUTLER, SNOW, O'MARA, STEVENS & CANNADA PLLC, 6075 POPLAR AVENUE, SUITE 500, MEMPHIS, TN, 38119, US

(73) Assignee: STAUF USA, LLC, Memphis, TN (US)

(21) Appl. No.: 12/411,019

(22) Filed: Mar. 25, 2009

(51) Int. Cl. B05C 17/10

(52) U.S. Cl. 15/235.4

(57) ABSTRACT

The present invention provides a trowel for applying two layers of flooring adhesive in one step. The trowel blade edge has spaced apart notches and pins protruding from the ridges formed by the spaced apart notches thus raising the trowel blade edge slightly off the floor.

### FIELD OF THE INVENTION

The present invention relates generally to trowels used for applying flooring adhesive.

### BACKGROUND OF THE INVENTION

Notched trowels are commonly used to spread adhesives on a substrate, such as a concrete slab or wooden sub floor, before the flooring, such as carpet, tile, or wood, is placed into the adhesive. The trowels serve two purposes: they are a measuring device to ensure that the right quantity of adhesive is spread on the substrate, and they also form ridges to ensure contact between the adhesive and the flooring to be installed. Carpet needs many small ridges close together, tiles need tall and wide ridges further apart.

For some specialty adhesives it is required to spread a full, closed layer of adhesive first and then build the ridges on top of that layer. The full, closed layer of adhesive serves as a moisture barrier or a crack membrane, the ridges on top glue down the wood or tile flooring. In such a case, the adhesive serves as both a moisture barrier or a crack membrane and glue for the flooring. Commonly this is achieved by using a very fine notched trowel for the first layer such as the prior art trowel edge shown in FIG. 1. After that very fine notched layer has dried a regular notched trowel such as one with a prior art trowel edge shown in FIG. 2 is used to spread a second coat, filling the voids of the first coat and building the ridges to install the wood or tile flooring. In such an application, two applications of adhesive must be made, thus making the process take two days or at least several hours with a drying period in between the two applications. There is a need in the field for a trowel that would be able to apply the two levels of adhesive simultaneously thus significantly reducing the amount of time necessary to install flooring.

### SUMMARY OF THE INVENTION

The present invention is a trowel for simultaneously applying a base layer and ridged upper layer of floor adhesive comprising a blade having a blade edge, the blade edge having a set of spaced notches and a minimum of five (5) pins on the blade edge protruding from the ridges caused by the spaced notches.

### BRIEF DESCRIPTION OF THE DRAWINGS

A more complete appreciation of the present invention and many attendant advantages thereof will be readily understood by reference to the following detailed description of the invention when considered in connection with the accompanying drawings.

In the drawings, FIG. 1 depicts the blade edge of a prior art trowel used for a first layer of adhesive.

FIG. 2 depicts the blade edge of a prior art trowel used for a second layer of adhesive.

FIG. 3 depicts the blade edge of an early test embodiment of a notched trowel with pins tried by the inventors which proved to have drawbacks.

FIG. 4 depicts the blade edge of the trowel of the present invention.

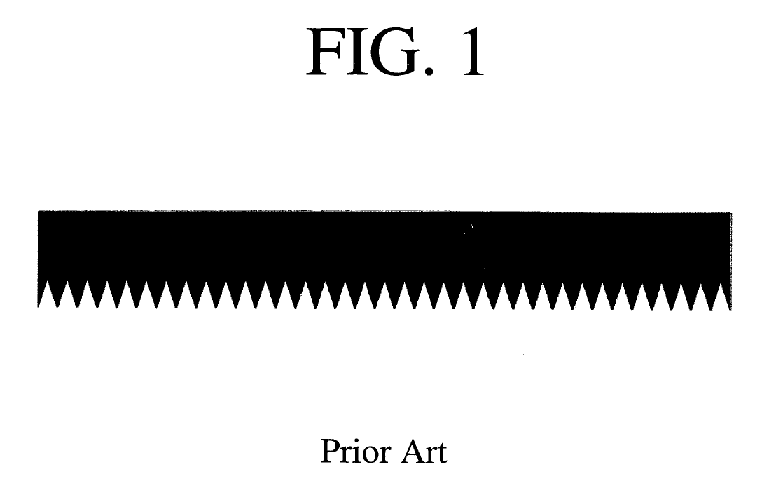

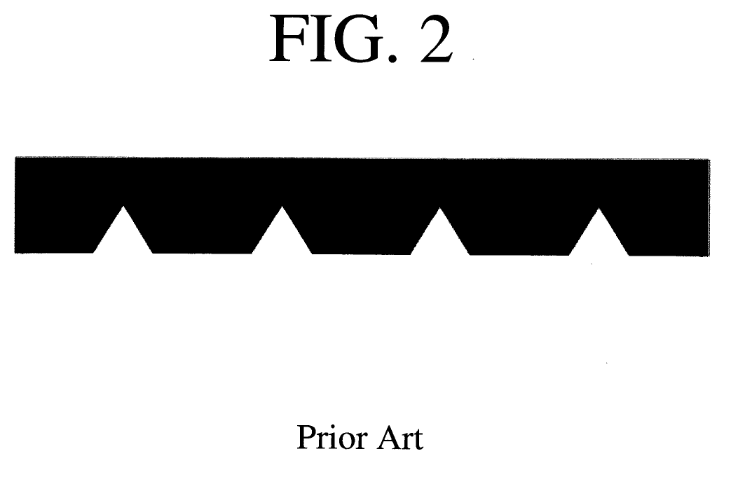

### DETAILED DESCRIPTION OF THE PREFERRED EMBODIMENT OF THE INVENTION:

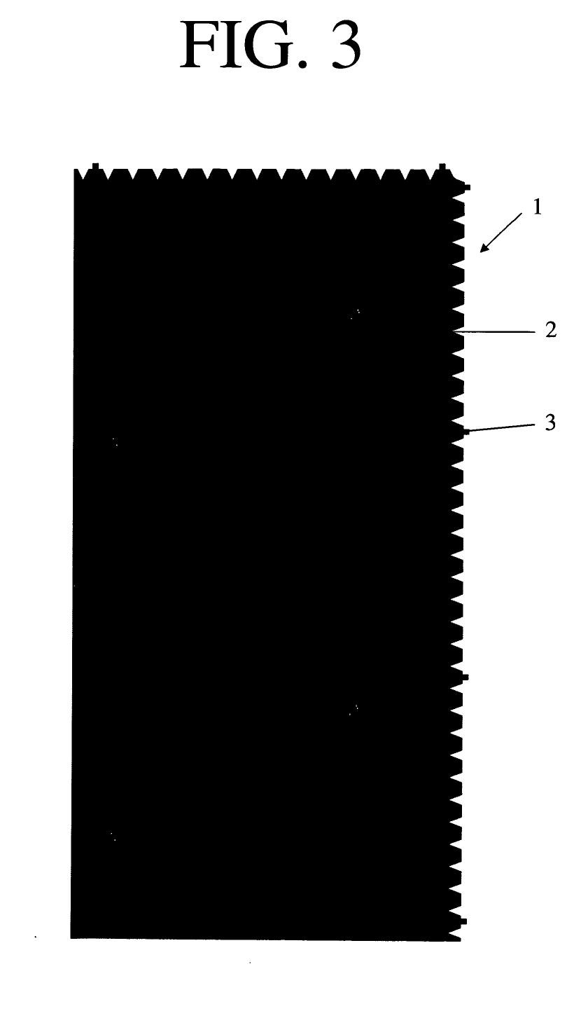

Referring now to FIG. 3, the inventors hereof first tried to achieve the result of an effective double layer of adhesive in one application by using a notched trowel having a trowel blade edge 1 with notches 2 which were 3.5 mm wide, spaced apart 4.5 mm and with depth 4 mm. The trowel blade edge 1 further had four (4) 2 mm-long pins 3 sticking out over the edge of the trowel blade edge 1 to lift the whole trowel 2 mm off the floor and therefore create the closed layer of adhesive with ridges on top (the “four pin embodiment”). The trowel marks left by the protruding pins 3 were closed once the flooring was laid into the adhesive by the ridges on both sides of the pin 3. In this trial phase, wood flooring was used.

The main problems with the four pin embodiment were the spread rate that was achieved with this trowel in that it left too much glue on the substrate to make it feasible, and the wear rate of the pins 3 was too high. The inventors could not reduce the thickness of the closed layer of glue using the trowel with trowel blade edge 1 depicted in FIG. 3, as the 2 mm are necessary to achieve the moisture barrier that will withstand 12 pounds of pressure over 1000 square feet over 24 hours. The inventors also could not reduce the amount of glue on top of the layer, otherwise the adhesion strength necessary to hold down the flooring would be lost.

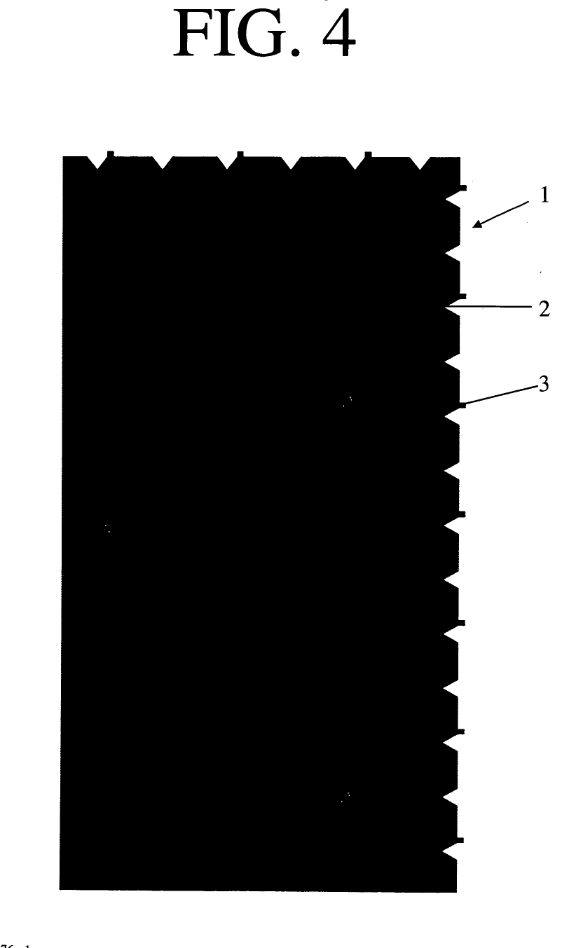

To solve the problems of the original four pin embodiment trowel, and as shown in FIG. 4, the inventors use more pins 3 to keep the trowel off the floor. The greater surface of the pins scratching on the floor reduces the wear and results in a longer life of the trowel. To increase the spread rate the ridges formed by the notches 2 were moved further apart, but at the same time made wider and higher, to still ensure a solid bond between the flooring and the substrate. In this preferred embodiment of the invention, pins 3 were evenly spaced with a minimum of five (5) pins on the trowel blade edge 1. The notches were 4.5-10 mm high, 4-6.5 mm wide, and spaced apart 5-15 mm. In a preferred embodiment, the notches were 4.8 mm high, 6.4 mm wide, and 14.3 mm spaced apart. A nice side effect of the improved trowel was the fact that with the higher ridges, the adhesive makes contact to the flooring even if it is slightly bowed, since the adhesive now reaches up higher than before.

1. A trowel comprising:
a blade having a blade edge,
the blade edge having a set of V-shaped spaced notches and a minimum of 5 pins on the blade edge protruding from ridges created by the spaced notches.

2. The trowel of claim 1 wherein the spaced notches are 4.5-10 mm high, 4-6.5 mm wide, and spaced apart 5-15 mm.

3. The trowel of claim 2 wherein the spaced notches are 4.8 mm high, 6.4 mm wide, and spaced apart 14.3 mm.
